(19) United States
(12) Patent Application Publication
(10) Pub. No.: US 2009/0090060 A1
(43) Pub. Date: Apr. 9, 2009

(54) DOORVALBEVEILIGING

(75) Inventor: Hans Antonius BORRA, Zeist (NL)

Correspondence Address: YOUNG & THOMPSON, 209 Madison Street, Suite 500, ALEXANDRIA, VA, 22314, US

(73) Assignee: KENNETT GMBH, Engelberg (CH)

(21) Appl. No.: 12/243,128

(22) Filed: Oct. 1, 2008

(30) Foreign Application Priority Data
Oct. 1, 2007 (NL) 1034450

(51) Int. Cl. E06B 9/02; E02D 29/14; E06B 9/00

(52) U.S. Cl. 49/9; 160/371

(57) ABSTRACT

Fall-through protection comprising a frame composed of four profiled sections, each consisting of profiled section parts. These profiled section parts can be displaced with respect to one another in order to adjust the length of the profiled sections. Couplings are provided in order to fix the adjusted length. Each profiled section has a stop which engages with the edge of the opening to be covered. Inside the profiled sections, a net is arranged. According to a particular embodiment, said net is attached to the profiled sections by means of plates which have eyelets which can be opened and closed.

### FIELD OF THE INVENTION

The present invention relates to a fall-through protection for building structures.

### BACKGROUND OF THE INVENTION

A fall-through protection is used as a temporary safeguard, in particular on flat roofs which are provided with an opening which is subsequently covered. When further activities are being carried out on the flat roof, there is a risk, during that temporary period, of persons falling as a result of being inattentive. A fall-through protection of this type can also be used on slightly sloping roofs or, floors between storeys).

### PRIOR ART

The fall-through protection comprises four hingedly connected tube assemblies, with each tube assembly comprising two tubes which can be displaced with respect to one another, as a result of which the dimensions of the space delimited thereby can be varied, depending on the size of the opening to be covered.

A net is provided between the tube assemblies in order to prevent someone from falling through and is attached to the tube assemblies in fixed positions. That is to say that every size delimited by the tube assemblies requires a different net. This makes it difficult to adapt the net in a simple manner, as there always have to be a number of separate nets which have to be replaced.

### SUMMARY OF THE INVENTION

It is an object of the present invention to provide a fall-through protection which can be fitted in a simple and unambiguous manner and which is no longer at risk of being inadvertently moved after fitting. Also, it is an object of the invention to enable a fall-through protection of this type to be fitted without damage to an existing structure and to enable a fall-through protection of this type to be removed in a simple manner after use.

This object is achieved according to a first aspect in a fall-through protection comprising a rectangular frame with four length-adjustable profiled sections and a net which is arranged between said profiled sections, in which the profiled sections are provided with a stop which projects substantially at right angles to the plane of said frame and, in the position of use, is situated under said net wherein the attachment means of said net on the profiled sections can be displaced with respect to the profiled sections.

According to an aspect the present invention, the profiled sections of the frame are provided with an extension or stop which comes to lie against the opening edge of the respective opening when the fall-through protection is being positioned correctly. The inner edge of the relevant opening fixes the fall-through protection and more particularly the frame thereof. Due to the weight of the frame, the frame will always lie on the opening and the stops will extend downwards from there, so that there is no risk of displacement. As a result thereof, the fall-through protection can be fixed in a particularly safe manner with respect to the roof in which the opening is provided. It should be understood that the invention can also be used in floors between storeys and the like, in which, for example, a stairwell or other temporary opening is provided in which a further structure is subsequently fitted. As a result of the fact that the attachment means of the nets can be moved with respect to the profiled sections, it is possible to use a net which is sufficiently large to cover the largest possible opening. If the opening becomes smaller, the net will, in the simplest case, sag, yet still offer a sufficiently high degree of safety.

In a preferred embodiment, additional safety is offered in that the corners of the attachment means of the nets are fixed. That is to say that it is not possible for a space to be created between the corner of the net and the corner formed between two adjoining profiled sections. More particularly, the structure is such that there is no space between these corners which is larger than 10×10 cm.

The above-described structure offers a considerable degree of adjustability, for example an adjustability of at least 50 cm in one or both directions which are at right angles to one another.

In addition, the fall-through protection according to the present invention can be fitted to and removed from the structure without damaging the latter, as the stops only bear against the edge of the opening and it is not necessary to attach them thereto in any way. The reason therefor is that there is always a stop of this type present on opposite sides of the profiled sections.

Preferably, the fall-through protection is embodied as a rectangular frame. However, it will be understood that it may be advantageous to embody the frame differently if there is a large number of openings of a different shape.

In the case of standard openings, it is possible to provide a ready-made fall-through protection which can simply be placed in the respective opening. If desired, a structure with profiled sections can be embodied to be collapsible by mounting two adjoining profiled sections in such a manner that they are only hingedly connected with respect to one another.

However, in many cases, it will be desirable to be able to adjust the size of the fall-through protection in situ. This can be achieved by producing the profiled sections in the form of length-adjustable profiled sections. It is for example possible to construct the profiled sections from profiled section parts which can be displaced with respect to one another and a lock in order to fix a mutual displacement of said profiled section parts.

The above-described stops can be arranged at any point on the profiled sections. By way of example, the “average” centre of the relevant profiled sections is mentioned. According to another advantageous embodiment of the invention, the stops are situated at the corners of the frame, that is to say the point where adjoining profiled sections meet. As a result thereof, it is possible to provide a particular combined structure for connecting the profiled sections to one another. If a stop is provided in the corner, it is possible to provide such a stop with elongate vertical (in the position of use) slots, so that the respective stop can be moved up and down vertically over a certain distance. In the case of such a structure, an auxiliary coupling piece is preferably present inside or adjacent to said stop and provides further engagement between the adjoining profiled sections. Preferably, the adjoining profiled sections are fixedly attached to the auxiliary coupling piece and the auxiliary coupling piece comprises two parts which pivot with respect to one another. As a result thereof, the adjoining profiled sections can be pivoted, for example in order to be folded in, but not slided. If desired, the structure is embodied in such a manner that pivoting is only possible if the stop has been partially moved with respect to the profiled sections or has been removed completely from the location where two adjoining profiled sections meet.

According to a particular embodiment of the present invention, the stops are arranged near the corners of intersecting (adjoining) profiled sections. As a result thereof, such stops no longer form an obstacle to the movement of the net over the profiled section.

The net which is used may comprise any net construction known in the prior art. Preferably, this is attached to the profiled sections by means of separate loops as the greatest amount of wear to the net occurs when it is attached to the profiled sections. This attachment means between the net and the profiled sections may comprise any conceivable construction, such as loops or securing plates. When using securing plates, it is preferable if these securing plates are provided with two openings. The purpose of one opening is to receive the respective profiled section while the purpose of the other opening is to engage with the net. Preferably, the latter opening is embodied as an open eyelet in order to enable the net to be replaced in a simple manner. If desired, safety measures may be provided so as to be able to close the eyelet to prevent the net from being removed from such an attachment means inadvertently. By using separate securing plates, the risk of damage to the net by burners and the like is reduced. In addition, a conflict between the net and the stops is prevented. The securing plates can preferably be pushed over any possible pipe couplings.

In order to provide further positioning and to prevent the net from sagging when the fall-through protection is not in its maximum opening position, it is proposed, according to a particular embodiment of the invention, to provide pretensioning means which force the net upwards. By additionally giving the net a conspicuous colour and the like, any persons present on the roof will be able to see the net from a distance.

The longitudinal adjustability of the profiled section can be controlled by telescopic profiled sections, such as tubes. These have to be fixed in the most advantageous position with respect to one another. Fixation can be brought about by any prior-art method, for example by means of tenon-mortise joints. However, according to a particular embodiment of the invention, a compression fitting system is used. According to another embodiment of the invention, the inner tube is provided with a snap lug which is subjected to a spring force and the outer tube is provided with corresponding openings. Fixation by means of a snap connection can also be achieved in other ways.

### DESCRIPTION OF THE FIGURES

The invention will be described below with reference to exemplary embodiments illustrated in the drawing, in which:

FIG. 1 shows a building provided with a flat roof with the fall-through protection according to the invention arranged thereon;

FIG. 2 shows a detail of the fall-through protection from FIG. 1;

FIG. 3 shows the fall-through protection from FIGS. 1 and 2 configured for securing a relatively small opening;

FIG. 4 shows a variant of the fall-through protection shown in FIGS. 1-3 for a relatively small opening;

FIG. 5 shows a variant of FIG. 4 in perspective for a relatively large opening;

FIG. 6 shows a detail of the clamp coupling for profiled section parts;

FIG. 7 shows a detail of the securing plate for the net;

FIG. 8 shows a detail of the stop of the embodiment from FIG. 4;

FIG. 9 shows a further detail of said stop;

FIG. 10 shows a structure according to FIGS. 8 and 9 without a stop and with a coupling piece;

FIGS. 11 and 12 show the collapsed position of the structure from FIG. 4;

FIG. 13 shows a variant of the connection between two tube parts; and

FIG. 14 shows a variant of the embodiment shown in FIG. 4 with pretensioning means.

### DETAILED DESCRIPTION OF THE PREFERRED EMBODIMENTS

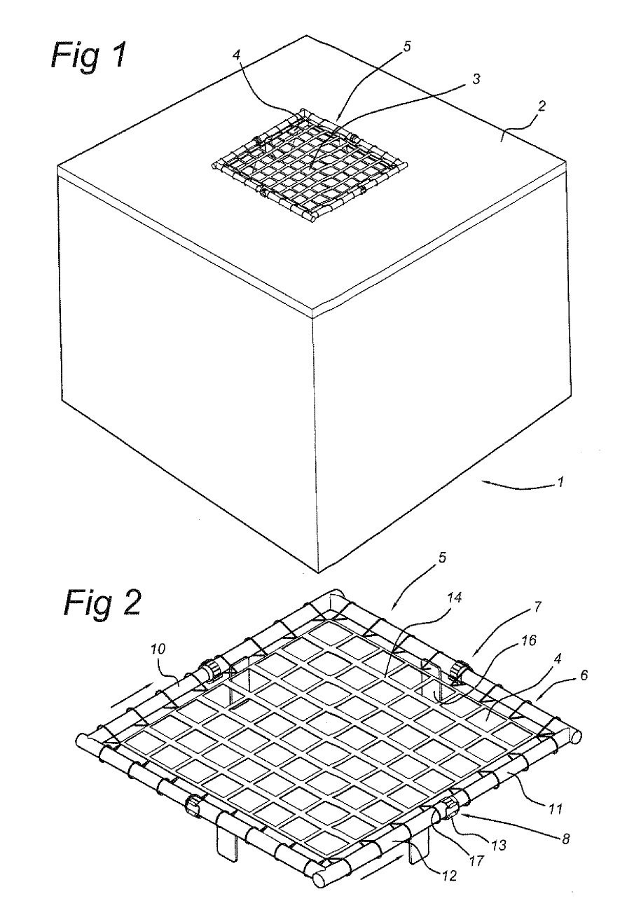

In FIG. 1, a building is denoted overall by reference numeral 1. It has a flat roof 2 which is provided with an opening 3. This may be an opening, for example, for a skylight. During construction, this opening will be open due to the risk of damage to such a skylight. Opening 3 is provided with an edge 4. As can be seen from FIG. 1, a fall-through protection 5 is used for as long as the opening 3 with edge 4 is not completely covered. It will be understood that this fall-through protection 5 can be used at any location where there are temporary openings which are a hazard for people who are present.

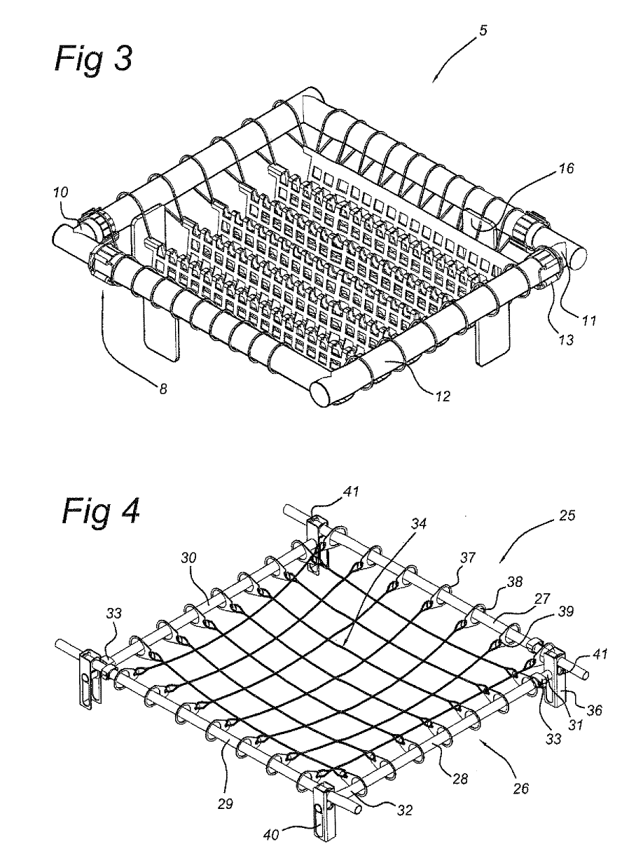

FIG. 2 shows details of the fall-through protection 5 from FIG. 1. This fall-through protection consists of a frame 6 composed of profiled sections 7, 8, 9, 10. Each profiled section 7-10 is composed of profiled section parts 11, 12 which are embodied to be displaceable with respect to one another. Using a compression fitting, the position of the profiled section parts 11 and 12 with respect to one another can be fixed. Inside the frame 6, there is a net 14. The size of the frame can be modified by means of the profiled section parts, as can be seen, for example, by comparing FIGS. 2 and 3. The net 14 is embodied to fit the largest desired dimensions of the frame 6. The net 14 is attached to the respective profiled sections 7-10 by means of loops 17.

Each profiled section is provided with a tab or stop 16.

The structure described above works as follows: the fall-through protection 5 is delivered in a relatively small position and is subsequently placed inside the opening with the tabs 16 directed downwards. This is the situation shown in FIG. 3. Then, the profiled section parts 11 and 12 are pulled out while the compression fitting 13 is inoperative, so that the tabs 16 touch the peripheral edge 4 of the opening 3. In this case, the profiled sections 7-10 automatically lie on the peripheral edge. In this position, the compression fittings 13 are operatively fixed, as a result of which the profiled section parts 11 and 12 can no longer be displaced with respect to one another. In this manner, a particularly safe structure is produced, as the fall-through protection according to the invention does not protrude, or hardly protrudes, with respect to the remainder of the roof, as a result of which the risk of falling is considerably reduced. In addition, it is not possible to remove the fall-through protection according to the invention inadvertently from the opening once it has been fitted, as the tabs or stops 16 prevent lateral displacement. The fall-through protection can be removed in a simple manner by releasing the couplings 13 and slightly pushing in the profiled section parts 11 and 12 again.

It should be understood that the tabs 16 can be embodied in such a manner that the contact with the peripheral edge is improved. Thus, it is possible, if desired, to provide openings in the latter for fitting a screw or the like which can be fitted in the peripheral edge 4 of the opening 3.

FIG. 4 et seq. show a variant of the fall-through protection from FIGS. 1-3 which is denoted overall by reference numeral 25 and also comprises a frame 26 with a net 34 arranged inside the latter. Frame 26 is composed of profiled sections 27-30. As in the previous case, this delimits a rectangle. However, it should be understood that any other shape can be delimited by the frame and that three or more than four profiled sections may be present in order to delimit the frame.

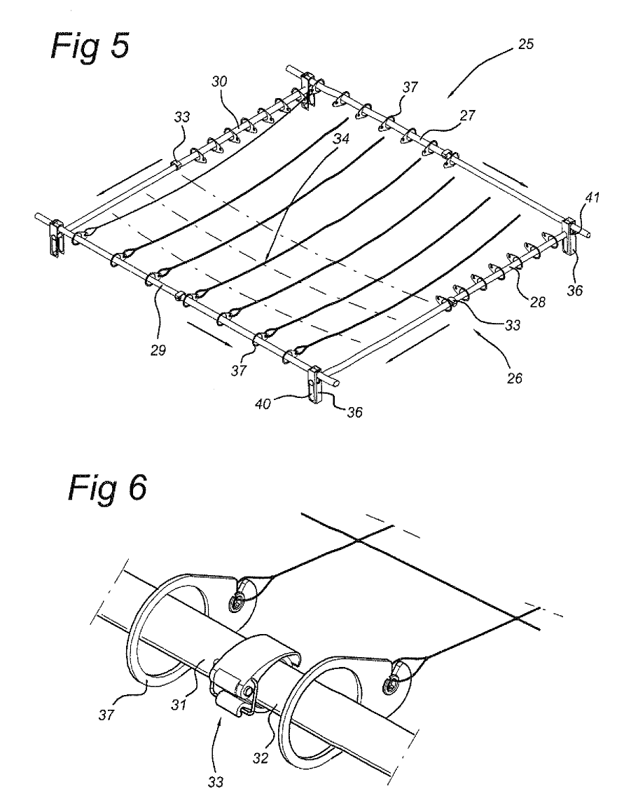

FIG. 4 shows a fall-through protection in the retracted position, while FIG. 5 shows the same in the extended or operational position.

The profiled sections each comprise telescopic profiled section parts 31, 32 which can be fixed by means of a compression fitting 33 in the above-described manner. Details of this compression fitting can be seen in FIG. 6. It will be understood that it is possible to fix the profiled section part 31 in any other way to profiled section part 32, such as for example by means of a series of openings which can be displaced with respect to one another, screw/sliding couplings acting in the axial direction of the tube, and the like. However, it is important that the person that is situated on the roof is able to see immediately whether the coupling is in a locked position, so that there is no risk of the profiled section parts 31 and 32 being displaceable with respect to one another after the frame according to the present invention has been fitted to the respective opening.

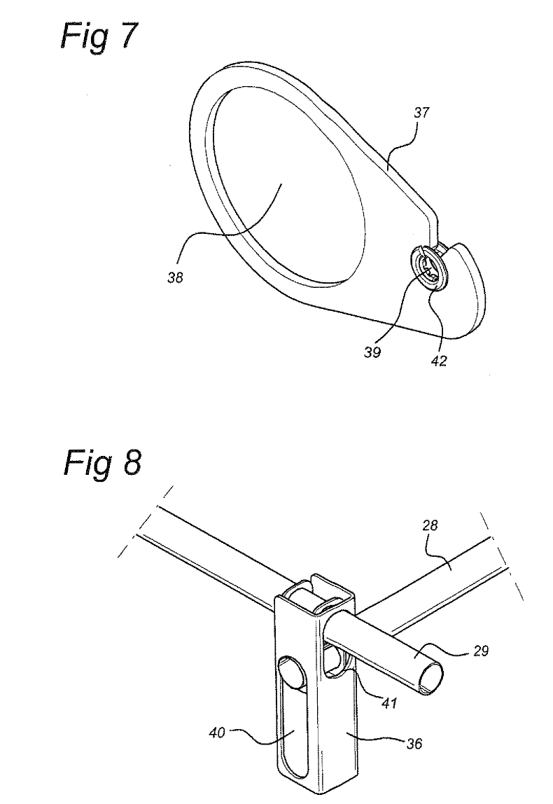

The net 34 is attached to the profiled sections 27-30 by means of plates 37. Details of plates 37 can be seen in FIGS. 6 and 7. Each plate comprises an eyelet 38 by means of which the plate is attached to the respective profiled section. In addition, each plate has an opening 39 for receiving the peripheral edge of the net 34. FIG. 7 shows that this opening is open for hooking the net in. In order to prevent the net from accidentally becoming detached, a rotatable retainer ring 42 is present inside opening 39. This retainer ring is also provided with an opening and when the opening of the retainer ring 42 is level with the passage of opening 39, the net can be introduced. As a result thereof this operation can be carried out in a simple manner when wear on the net occurs or when the net is due to be replaced.

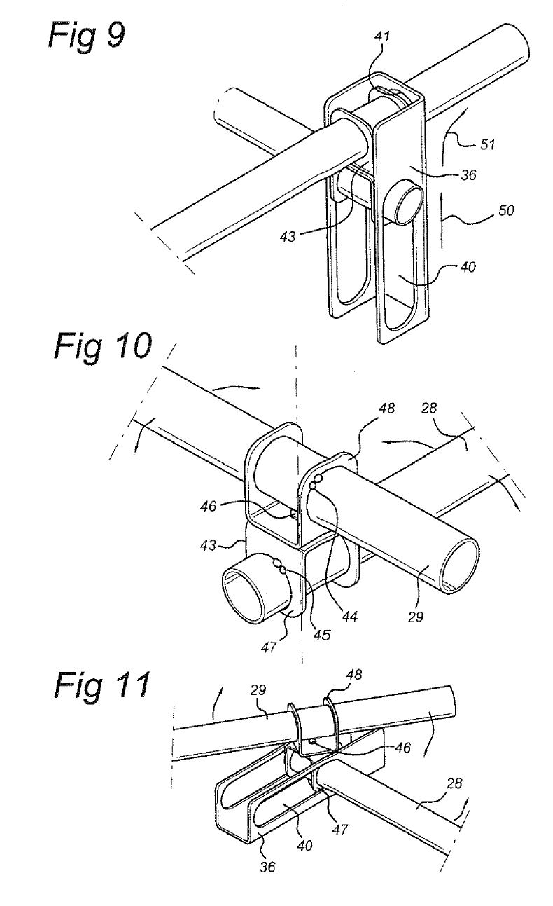

When comparing FIGS. 1-3 and FIG. 4 et seq., it becomes clear that the stop in the embodiment from FIG. 4 et seq. has a slightly different embodiment. It is still provided on the profiled sections and denoted by reference numeral 36, but is now situated near the corners formed by two intersecting profiled sections. In addition, this stop 36 functions to fix the intersecting profiled sections with respect to one another. As can be seen in FIGS. 8 and 9, stop 36 is composed of a substantially U-shaped profiled section comprising elongate slots 40 and 41. Therein, slot 40 functions to accommodate profiled section 28 so as to be displaceable in the vertical direction and slot 41 to accommodate profiled section 29 so as to be displaceable vertically. It will be understood that the other corners are embodied in the same manner. In addition, with this variant, only the ends of the profiled sections rest on the edge of the opening rather than the intermediate parts of the profiled sections.

As is shown in FIGS. 9 and 10, in the fitted position, an auxiliary coupling piece 43 is provided in the corner 36 which acts as a stop or tab. Auxiliary coupling piece 43 consists of pas 47 and 48 which can be rotated with respect to one another by means of hinge 46. Reference numerals 44 and 45 in each case denote a weld which indicated that the profiled section 29 is non-displaceable with respect to part 48 and profiled section 28 is non-displaceable with respect to part 47.

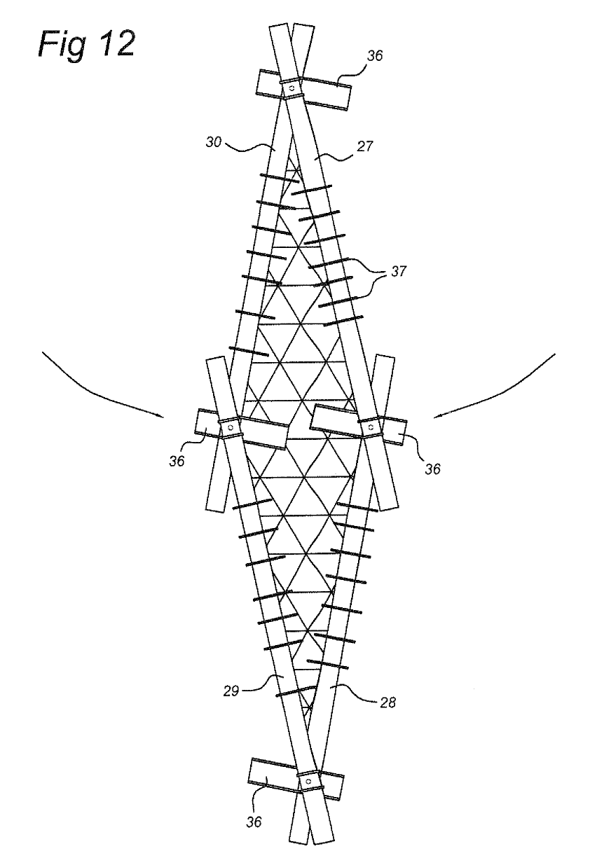

Due to the elongate slots 40 and 41, it is possible, in the non-fitted state, to move corner piece 36 with respect to the profiled sections 28 and 29 (arrow 50 in FIG. 9). Following this, the corner piece is only connected to one profiled section and can be tilted away in the direction of arrow 51 (see also FIG. 11). Then, these profiled sections 28 and 29 can pivot with respect to one another and be brought in line with one another (folding in). Thus, a particularly space-saving structure is achieved which can easily be stored and transported (see FIGS. 11 and 12).

When the use of the fall-through protection is desirable, the corner piece 36 is fitted, preferably on the building site. This forces the user to place the profiled sections 29 and 28 and other profiled sections in positions at right angles to one another, resulting in the structure which is illustrated in FIG. 4. Thereafter, the fall-through protection can be adapted to the respective opening 4 in the roof in an optimum manner by extending the profiled sections. When the optimum position has been reached, the corner pieces 36 are situated in the corners as stops. As a result of the force of gravity, the corner pieces 36 always move downwards with respect to the profiled sections, resulting in a position in which the profiled sections are locked with respect to one another. By then operating the compression fittings, that is to say by in each case fixing the profiled section parts 31 and 32 with respect to one another, the fall-through protection can be fixed with respect to the respective opening.

A fall-through protection according to the invention can be used on a large range of openings. However, it is possible to introduce embodiments of different sizes onto the market, as a result of which all kinds of openings can be covered.

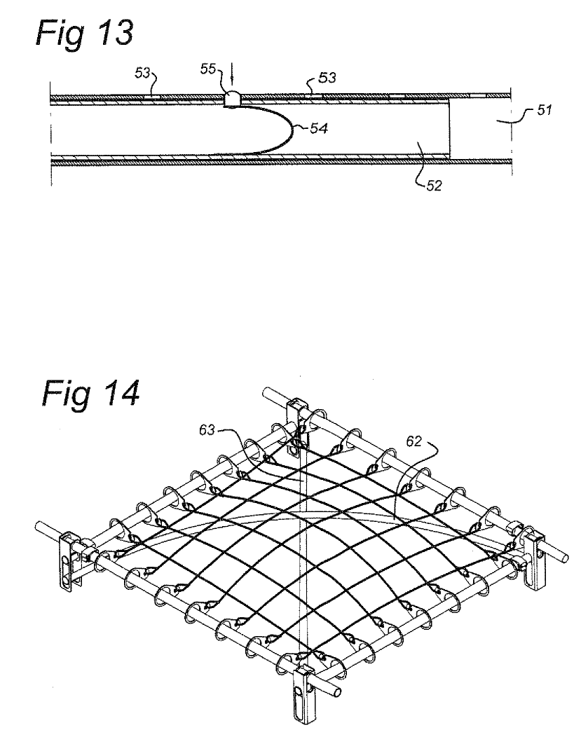

FIG. 13 shows two tube parts 51 and 52 which are displaceable with respect to one another and form one of the profiled sections of the fall-through protection as shown in the earlier figures. Therein the inner tube 52 is provided with a push-button 55 which can be moved outside the surface of the inner tube part 52 by forcing it to the outside by means of a spring 54. By operating it, this button 55 can be brought level with the outer tube surface of the inner tube part 52. The outer tube part 51 is provided with openings 53 at regular intervals which serve as locking openings for push-button 55. Push-button 55 may have a bright colour or the like.

As, according to a particular embodiment of the invention, the position of the profiled sections is fixed in terms of rotation due to the particular embodiment of the corner structure, it is only necessary to provide holes 53 in the outer tube part 51, it being ensured that push-button 55 always comes to lie in front of these holes.

FIG. 14 shows a variant of FIG. 4. The same reference numerals are used as in FIG. 2. However, in this variant two flexible rods 62 and 63, for example rods made of carbon material, are provided which force the net 14 upwards. As a result thereof, the net is, on the one hand, always tensioned and, on the other hand, protrudes above the plane of the opening, thus providing a warning effect. The latter can be improved by using bright colours for either the rods 62, 63 or the net 14 and/or both.

Upon reading the above, those skilled in the art will understand that the fall-through protection according to the present invention can be transported and stored in a very simple manner. Subsequent installation on the building site is also very simple, and removal can be carried out quickly. However, after it has been installed, the fall-through protection is sufficiently safe to ensure that it cannot be inadvertently displaced with respect to the respective opening. It has been found that the above-described structure can withstand large forces which act on the net in the vertical direction.

Apart from in building construction, the present invention can also be used in the production of technical installations, vessels, aeroplanes and in order to cover manholes and the like.

Upon reading the above, those skilled in the art will be able to think of variants. These are obvious and are covered by the scope of the attached claims.

1. Fall-through protection comprising a rectangular frame with four length-adjustable profiled sections and a net which is arranged between said profiled sections, in which the profiled sections are provided with a stop which projects substantially at right angles to the plane of said frame and, in the position of use, is situated under said net, wherein the attachment means of said net on the profiled sections can be displaced with respect to the profiled sections.

2. Fall-through protection according to claim 1, wherein the attachment means of said net which are closest to the corners of intersecting profiled sections are fixed.

3. Fall-through protection according to claim 1, wherein said attachment means comprise loops which are arranged around said profiled sections and are connected to the net.

4. Fall-through protection according to claim 1, wherein said stop is arranged at a corner of said frame.

5. Fall-through protection according to claim 1, wherein said stop comprises an extension which is embodied as a coupling piece for two profiled sections.

6. Fall-through protection according to claim 5, wherein said stop comprises a slot for accommodating a profiled section in a height-adjustable manner and in which an auxiliary coupling piece is provided for connecting said profiled sections.

7. Fall-through protection according to claim 6, wherein said auxiliary coupling piece is pivotable in order to fold up adjoining profiled sections against one another.

8. Fall-through protection according to claim 1, wherein said net attachment means comprise plates having an eyelet for accommodating a profiled section and an eyelet for accommodating a net edge.

9. Fall-through protection according to claim 8, wherein said eyelet is embodied in such a manner that it can be closed in order to accommodate a net edge.

10. Fall-through protection according to claim 1, wherein two profiled sections are arranged adjoining one another in a corner and non-displaceably with respect to one another.

11. Fall-through protection according to claim 1, comprising pretensioning means which, in the fitted position, force the net upwards.
